(19) United States
(12) Patent Application Publication
(10) Pub. No.: US 2008/0291844 A1
(43) Pub. Date: Nov. 27, 2008

(54) Direct Sequential Network Addressing (Dsna)

(75) Inventor: Christian Krause, Aarhus C (DK)

Correspondence Address: WINSTON & STRAWN LLP;PATENT DEPARTMENT, 1700 K STREET, N.W., WASHINGTON, DC, 20006, US

(73) Assignee: VIP 1 Aps, Aarhus C (DK)

(21) Appl. No.: 12/094,825

(22) PCT Filed: Nov. 22, 2006
(86) PCT No.: PCT/DK06/00651

§ 371 Date: May 23, 2008

(30) Foreign Application Priority Data
Nov. 24, 2005 (DK) PA 2005 01648

(51) Int. Cl. H04L 12/28

(52) U.S. Cl. 370/254

(57) ABSTRACT

A system that includes a network server and a number of network clients connected to the server through a daisy chained network. These network clients include a clamper circuit parallel coupled to the daisy network, with the clamper adapted to detect a signal transmitted through the daisy network and adapted to short circuit the daisy network when the signal has been detected. A detect and blocking circuit can detect a signal on the transmission line via measuring voltage or current going trough the transmission line, and as a result of a detection block or interrupt the signal. The detect and blocking circuit can be enabled and disabled by the network client controller in that a detect and blocking instance is memorized by detect and blocking circuit enabling the network client controller to acquire the detect and blocking circuit if a detect and blocking instance has occurred.

### FIELD OF THE INVENTION

The use of data networking is increasingly being implemented into all sorts of applications. When working with applications which uses daisy chained network configurations, each device on the network chain needs an individual network address to enable individual communication.

A number of these applications require the network address or network ID, to be sequentially number in the order they are connected to the network.

These types of applications could be a series of lighting devices, building management systems, sensor lines in fabrication facilities, traffic monitoring application etc. In any system where the device ID should correlate linearly with the distance on the network cable from the network server to the individual client devices.

Today this type of addressing could be performed by using a separate addressing wire as described in U.S. Pat. No. 5,450,072 which requires an extra addressing wire in addition to the information wire. Using this type of sequential addressing does not allow the addressing and information wire to one and same wire as the required impedance (4) inserted in series addressing wire at each unit would compromise the impedance and therefore the integrity of the information being sent, and it is therefore needed to have to separate wires one for information and one for addressing and therefore increasing the cost of the wiring between the units, and are in some case impossibly to achieve as communication standards does not have spare wires specified for this purpose.

U.S. Pat. No. 6,700,877 describes a way of assigned a number of units with an unique address but in respect to the physical distance between the devices on a communication wire.

One known way of having both information and sequential addressing in one and same transition wire to achieve automatic sequential addressing, could be done by opening the transmission line during addressing to recognize devices. In such a system is transmission line going trough each device via an open/close circuit which allows data to be cut of to secondary successive client devices. Sequentially addressing is then achieved with all network clients cutting off any transmission to secondary clients at the start of the addressing procedure. The network server can then only discover the first client on the transmission line. When first device has been discovered the first client stops cutting off transmission to its secondary client which then is discovered. The process is then repeated until all devices have been discovered.

The method of opening the transmission line has several drawbacks making it unfeasible to implement, these points are described below.

1. Network client can not be connected in a T fashion as shown in FIG. 2a instead the transmission line needs to pass through the network client as shown in FIG. 2b.
2. The network client needs to be able to switch off secondary devices by using a switch such as a relay or semiconductor. In case switch fails will communication to all secondary devices be lost.
3. Using a relay as switch is undesirable as relays are mechanical and tends to fail over time and does not withstand static electric shocks well over time.
4. Using a semiconductor as switch is also undesirable because they as well cannot withstand static electric shocks and when power is lost or turned off at one client, is transmission also cut of to secondary clients. Semiconductors never have completely constant and low impedance at different frequencies and can thereby change the impedance of the transmission line resulting in undesired reflection on transmission line.

The “Direct Sequential Network Addressing” solves all of these issues and is described below. The “Direct Sequential Network Addressing” method will from now on be described as the “DSNA”.

### OBJECT AND SUMMARY OF THE INVENTION

The object of the invention is to solve the problems described above.

A system comprising a network server coupled to and a number of networks clients connected to said networks server through a daisy chained network where said networks clients comprises a clamper circuit parallel coupled to said daisy network, said clamper comprises detection means adapted to detect a signal transmitted through said daisy network and clamping means adapted to short circuit said daisy network when said signal has been detected by detecting a signal on the transmission line via measuring voltage or current going trough the transmission line, and as a result of a detection block the signal 32 or by other means interrupt the signal, where the detect and blocking circuit 41 can be enabled and disabled 38 by the network client controller 33, characterized in that a detect and blocking instance is memorized by the detect and blocking circuit enabling the network client controller 33 to acquire 37 from detect and blocking circuit 41 if a detect and blocking instance has occurred. In that said detect and blocking circuit will block signal 34 at first network client leaving a rest-signal 35 traveling down the transmission line, where rest-signal on a transmission line with an efficiency of X will result in the rest-signal decaying at a given rate given by X down the transmission line, resulting in network clients placed subsequently not detecting the decayed rest-signal 36 if spaced probably apart resulting in that said detect and blocking instance can be used to determine the physical order of a series network clients on a transmission line each having a detect and blocking circuit 41. and by network clients having a common predefined algorithm FIG. 4 enabling and disabling the detect and blocking circuit 41 in such a way that all physical placement of network clients can be determined by network server.

The method of changing the efficiency of a balanced transmission line by disabling one line 51 in a balanced pair via disconnecting the line or by other means changing the balance between the two pairs decreasing the efficiency of the transmission line, this method of decreasing the efficiency of a transmission line to increase the rate at which a rest-signal decrease as it travels down a transmission line and thereby enabling shorter distance between network clients without a rest-signal will be detected by a network client.

### BRIEF DESCRIPTION OF THE DRAWINGS

In the following, preferred embodiments of the invention will be described referring to the figures, where

FIG. 1 illustrates data network consisting of a server and multible number of clients.

FIG. 2a illustrates the client connected in parallel to a data network.

FIG. 2b illustrates the client connected in serial to a data network, with the ability do disconnected data subsequent clients.

FIG. 3 illustrates an embodiment of the present invention

FIG. 4 illustrates a flow diagram of generating sequential addressing.

FIG. 5 illustrates the ability to make a balance communication line unbalanced to reduce lifetime of rest pulse

### DESCRIPTION OF EMBODIMENTS

In this document are shortened words used for simplifying the description, which are defined below.

Sequential addressing: Network using client device addresses or ID's in correlation with cable distance to the network server.

Network ID: A network address or ID's representing a specific network client device.

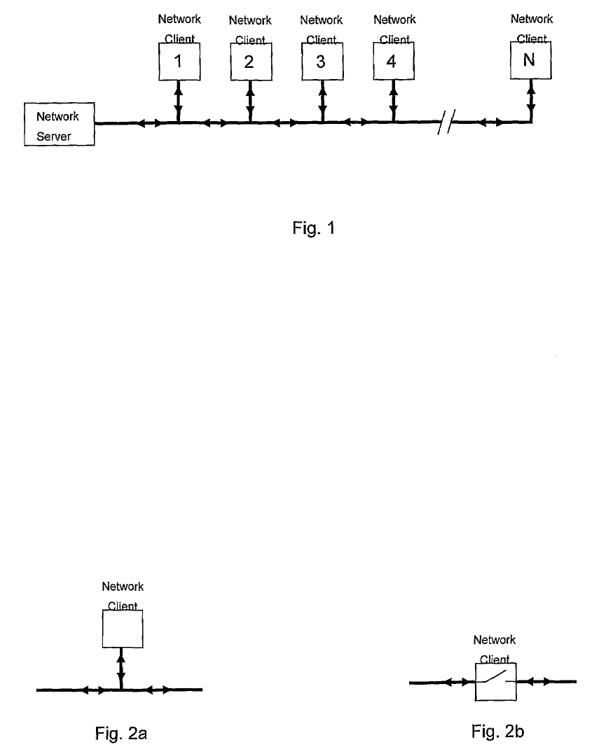

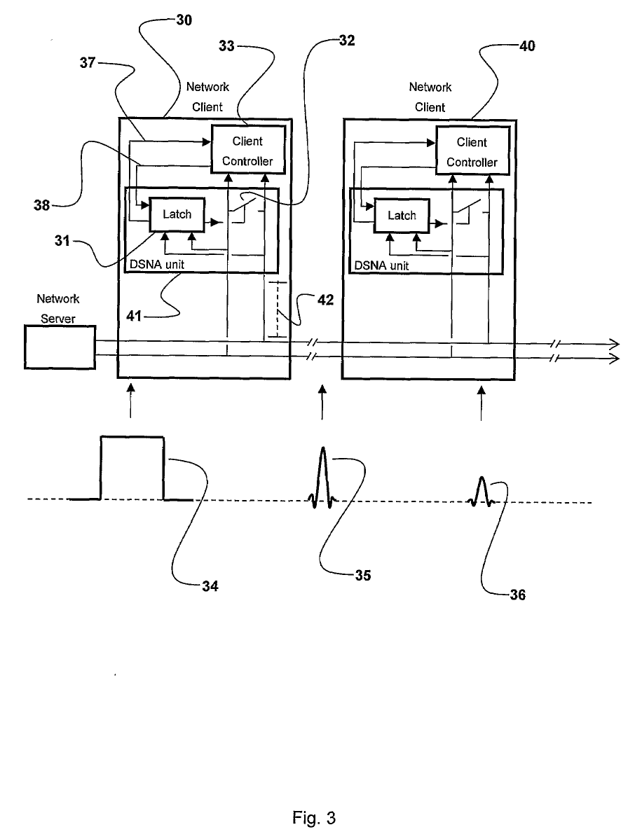

The purpose of this invention is to create a solution to automatically generate network ID's in correlation with the cable distance to the network server without breaking or inserting any impedance or other device in series with the transmission line but to have network client connected in parallel with the passing transmission line as shown in FIG. 1 where the first device is given ID 1 and the next 2,3,4 to N based on the clients distance to the Network server.

The DSNA method is show in FIG. 3 using a two wire transmission line such as twisted pair cable.

The DSNA unit 41 is shown implemented network client 30 consisting of a latch 31 and switch 32. The switch 32 could be realized by using semiconductor or similar to get a desired short close time.

When a pulse 34 is transmitted by the network server will it when it reaches latch 31 trigger the latch that then will trigger the closure of switch 32. Switch will remain closed until the latch is reset from the client controller 33.

The outcome of the latch 31 clamping the transmission line via switch 32, results in the pulse 34 being cut, resulting in a remaining much shorter pulse 35.

The length of the remaining pulse 35 is depended on the sum of propagation-delay of latch 31 and switch 32 and the length 42 between DSNA unit 41 and transmission line, which should be as short as possible.

As all transmission lines in reality never can be 100% lossless, will the remaining pulse 35 decade as it travels down the transmission line. The rate of which the remaining pulse 35 decreases with the distance traveled on the transmission line depends on the bandwidth efficiency of the transmission line and the length of the remaining pulse 35. This can be proven because the width of the remaining pulse 35 approximately equal ½ of 1st order wavelength characterizing the pulse 35, so the shorter the pulse is, the higher the transmissions line bandwidth need to be to carry it the same length.

If the next successive network client 40, with the same DSNA circuit 41 implemented as in network client 30, is placed with far enough distance on the transmission line from the first network client 30 will the pulse 35 have decreased in amplitude to pulse 36 that is to low to trigger network client 40 DSNA circuit.

The DSNA circuit in any following network clients will therefore as well not trigger. We can therefore conclude that the first network client on the transmission line in distance to the network server must be the one where the DNSA circuit is triggered.

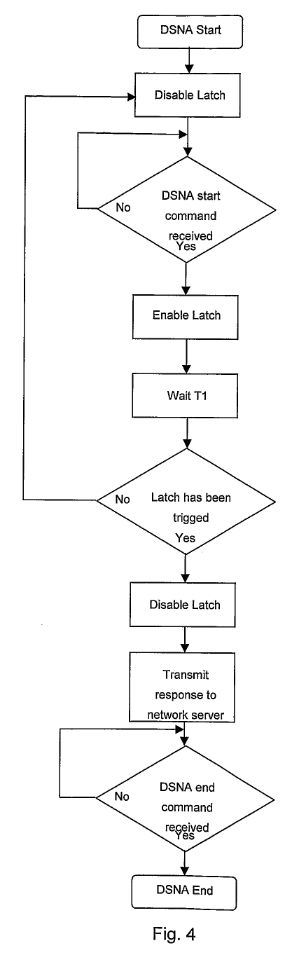

The client controller 33 reads back the result from the DSNA circuit 41 after a preset time via the result line 37 and then disables the DSNA circuit via the disable line 38 and transmits back to the network server the result, note that during transmission on the line all network clients must disable there DSNA circuits not to corrupt data transmitted between clients and server. A specific timing scheme must therefore be predetermined. A flowchart of the discovery process can be seen in FIG. 4, note that disabling the latch 31 will as well perform a reset of the latch 31.

The process is then repeated until all network clients have been discovered, and the order they are discovered equals the relative distance they are placed from the network server a successful sequential network addressing has been performed.

As explained previously is the minimum distance between network clients required to get a successful DSNA process without two network clients DSNA circuits triggering to the same signal, is dependent on the bandwidth of the transmission line and the length of the remaining pulse 35.

To get shortest possible minimum length between devices requires that the remaining pulse 35 becomes as short as possible meaning that the DSNA circuit has to react as fast as possible. The DSNA circuit should therefore be realized with as few components as possible to minimize propagation delay in the DSNA circuit.

It is desired to have as short as possible minimum length between client devices to enable the possibility to have as short as possible transmission line between client devices if desired. It is therefore essential that the remaining pulse becomes as short as possible to achieve the shortest possible minimum distance between network clients for a successful DSNA process to occur.

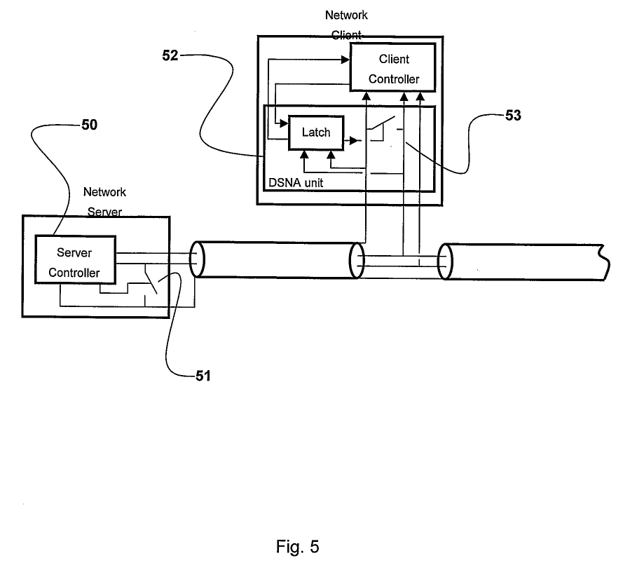

Lowering the bandwidth of the transmission line during DSNA addressing might seem like an impossible task, but it is actually achievable on certain transmission lines. An example is a transmission line realized by using shielded twisted pair, the main part of the bandwidth efficiency of such a cable is dependent on the balance between the two wires in the twisted pair. Putting the pair out of balance will greatly reduce the bandwidth of the cable. This can be done by disabling one of the wires in the pair by disconnecting it or in this example connecting it to the shield as shown in FIG. 5.

The server controller 50 can then clamp one of the wires in the twisted pair during DSNA via switch 51 and thereby achieve a lower bandwidth of the transmission line during DSNA operation. As shown in the network client is the DSNA unit 52 only using the active wire 53 in the twisted pair and the shield as reference. This can also be achieved in non shielded cables by using a third wire as ground.

1-18. (canceled)

19. A system comprising a network server and a number of network clients connected to the network server through a daisy chained network where the network clients comprise a clamper circuit parallel coupled to the daisy network, the clamper comprising detection means adapted to detect a signal transmitted through the daisy network and clamping means adapted to short circuit the daisy network when the signal has been detected.

20. The system of claim 19, wherein the detect and blocking circuit can detect a signal on a transmission line by measuring voltage, current or both going trough the transmission line, and as a result of a detection block or interrupt the signal.

21. The system of claim 20, further comprising a network client controller and wherein the detect and blocking circuit can be enabled or disabled by the controller.

22. The system of claim 21, wherein the detect and blocking instance is memorized by a detect and blocking circuit enabling the network client controller to acquire the detect and blocking circuit when a detect and blocking instance has occurred.

23. The system of claim 20, wherein the detect and blocking circuit will block the signal at a first network client leaving a rest-signal traveling down the transmission line, where rest-signal on a transmission line with an efficiency of X will result in the rest-signal decaying at a given rate given by X down the transmission line, resulting in additional network clients not detecting the decayed rest-signal.

24. The system of claim 22, wherein the detect and blocking circuit and instance can be used to determine the physical order of a series network clients on a transmission line each having an detect and blocking circuit.

25. The system of claim 20, wherein the network clients have a common predefined algorithm for enabling and disabling the detect and blocking circuit in such a way that all physical placement of network clients can be determined by network server.

26. A method of changing the efficiency of a balanced transmission line by disabling one line in a balanced pair via disconnecting the line or by changing the balance between the two pairs to decrease the efficiency of the transmission line.

27. The method of claim 26, wherein the efficiency of the transmission line is decreased to increase the rate at which a rest-signal decreases as it travels down a transmission line, thereby enabling a shorter distance between network clients before a rest-signal will be detected by a network client.

28. A network client adapted to be connected to a network server through a daisy chained network where the network client comprises a clamper circuit parallel coupled to the daisy network, with the clamper comprising detection means adapted to detect a signal transmitted through the daisy network and clamping means adapted to short circuit the daisy network when the signal has been detected.

29. The network client of claim 28, wherein the detect and blocking circuit can detect a signal on a transmission line by measuring voltage, current or both going trough the transmission line, and as a result of a detection block or interrupt the signal.

30. The network client of claim 29, further comprising a network client controller and wherein the detect and blocking circuit can be enabled or disabled by the controller.

31. The network client of claim 29, wherein the detect and blocking instance is memorized by a detect and blocking circuit enabling the network client controller to acquire the detect and blocking circuit when a detect and blocking instance has occurred.

32. The network client of claim 29, wherein the detect and blocking circuit will block the signal at a first network client leaving a rest-signal traveling down the transmission line, where rest-signal on a transmission line with an efficiency of X will result in the rest-signal decaying at a given rate given by X down the transmission line, resulting in additional network clients not detecting the decayed rest-signal.

33. The network client of claim 29, wherein the detect and blocking instance can be used to determine a physical order of a series network clients on a transmission line each having a detect and blocking circuit.

34. The network client of claim 29, which has a common predefined algorithm for enabling and disabling the detect and blocking circuit in such a way that all physical placement of other network clients can be determined by network server.
